(19) United States
(12) Patent Application Publication
(10) Pub. No.: US 2024/0349939 A1
(43) Pub. Date: Oct. 24, 2024

(54) Container for Food

(71) Applicant: Maurizio Fanelli, San Severo (FG) (IT)

(72) Inventor: Maurizio Fanelli, San Severo (FG) (IT)

(21) Appl. No.: 18/684,764

(22) PCT Filed: Aug. 22, 2022
(86) PCT No.: PCT/IT2022/050236

§ 371 Date: Feb. 19, 2024

(30) Foreign Application Priority Data
Aug. 20, 2021 (IT) 102021000022154

(51) Int. Cl. A47J 36/12; A47J 36/38

(52) U.S. Cl. CPC A47J 36/12; A47J 36/38

(57) ABSTRACT

A container for preparing food comprises a base body, a cover, and a support. The base body defines, by means of a bottom wall and a side wall, a chamber for food preparation. The cover has a central portion configured to define an upper wall of the chamber and a peripheral portion which extends away from the central portion and is peripherally external and facing the side wall while in use so as to protect the base body from the entrance of external elements (contaminants). The support is configured to distance the cover from the base body so as to maintain a lower edge of the peripheral portion at most at a same height as an upper edge of the side wall. This way allows for the free flow of an air flow to and from an external environment with respect to the chamber.

### TECHNICAL FIELD

The presented invention falls into the sector of kitchen tools for preserving and processing food, in the domestic, industrial, and food service fields.

In particular, it consists of a container specifically designed for preventing the contamination of food during its preparation.

Such a container is intended for people affected by food intolerances or allergies and particularly for people affected by coeliac disease: in fact, it makes it possible to cook and preserve food preventing the contamination of elements that are potentially noxious for these people (specifically the contamination of gluten), even in the presence of such elements in the same cooking and preservation environment.

The container is mainly intended to cook food in ovens (electric ovens, gas ovens, and wood ovens), but it can also be used with gas stoves, electric cooktops, and induction stovetops.

### BACKGROUND ART

With regards to the specific context of gluten cross-contamination, AIC (Italian Association for Coeliac disease) introduced the guidelines for cooking gluten-free food into pizzerias' and pizza makers' ovens. These guidelines—which were shared with and approved by the Public Health institutions—include two alternative procedures to ensure food safety for people affected by the coeliac disease:
using a dedicated oven for gluten-free food products;
using the same oven for both gluten-containing and gluten-free food with some precautions while cooking the gluten-free one (stopping the cooking of gluten-containing pizzas, using a baking tray with high enough side walls, keeping the gluten-free pizzas covered until they are inside the oven, limiting the movements of the pizza peel/shovel).

With regard to the domestic context, AIC says that it is possible to use the same domestic oven for contemporarily cooking gluten-containing and gluten-free food being
very careful while moving baking trays in order to avoid food residuals containing gluten to fall down on gluten-free food.

In this context, a useful and very simple precaution can be to cook gluten-free foods on the higher shelves of the oven and those containing gluten on the lower ones.

In fact, gluten contamination occurs essentially by contact with contaminated surfaces (dirty shelves, cutlery, plates, or pots, which have been used in contact with foods containing gluten) or by direct contact with foods containing gluten.

There are no other known techniques or recommendations for the safe cooking of gluten-free foods in environments where contaminants are present. However, a safe solution could be the use of containers fully and hermetically covered by a lid in order to isolate the internal cooking environment from the external one in which there may be contaminants (paying attention to the phase of opening the container and moving the content): moreover, this solution would allow protecting the content of the container even in the event of aerial dispersion (i.e. in the air) of contaminating elements, such as that caused by the use of bellows for wood-fired ovens near deposits of contaminating residues (such as the so-called dusting flour).

Finally, sometimes it happens that kitchen users utilize aluminum foil to create handcrafted lids to cover the trays and protect them from the entrance of contaminants.

The limitations of the current techniques and prescribed procedures are immediately clear.

In the case of the use of ovens in a professional environment, there are logistical and economic problems with regard to the first AIC procedure (there is not always space for a dedicated oven, which in any case requires an economic investment that may not be convenient in light of the niche nature of the coeliac customer segment), while the second AIC procedure consists of the suspension of the cooking of foods containing gluten which is uneconomical or even impractical in peak moments of activity when a decrease in production capacity cannot be afforded.

In the case of domestic ovens, the management of the risk of falling gluten-containing residues is entirely left to the user. Moreover, the recommendation to use only the upper floors of the oven could limit the cooking of certain foods that need to be moved to different floors during cooking due to the position of the heating elements (e.g., resistors) in specific parts of the oven (e.g., only at the top) which does not make cooking homogeneous.

As for the use of fully and hermetically covered containers, this is not applicable or advisable except for limited cases as such a cooking environment would not allow optimal cooking of the food (since the convective heat transfer mediated by hot air flow would be missing and heating would take place only by thermal radiation and conduction): moreover, it would also create an isolated environment characterized by the stagnation of water vapor that can alter the consistency of the food (this effect is particularly undesirable for foods that must maintain a certain external dryness such as the edge and bottom of pizzas).

With regard to this aspect, containers for cooking food are known in which, while in use, the lid is slightly raised with respect to the base that defines the cooking chamber for food.

However, this type of container only allows a release of the pressure accumulated inside the cooking chamber by reducing the stagnation of water vapor, but it does not allow the free flow of air flows, thus reducing the overall quality of the cooking process.

Alternatively, in the opposite direction, solutions are known in which the lid is completely separated from the cooking chamber in order to simply provide the user with minimal protection against any splashes caused by cooking food.

These solutions allow the free flow of air to and from the cooking chamber, but they do not provide any protection against contaminants that are completely free to come into contact with the food being prepared.

Finally, the use of homemade solutions with aluminum foils is highly inadvisable for reasons related to environmental impact and risk of contamination since the construction of the aluminum lid is not controlled and could therefore result in vulnerabilities in the structure; in addition, the Italian Ministry of Health has warned consumers against the use of aluminum in contact with acidic substances as it could release metal particles to a degree that is toxic to humans.

Therefore, there is a strong need to develop new containers capable of allowing at the same time optimal cooking of food and protection of the same from any contamination.

### BRIEF DISCLOSURE OF INVENTION

In the overall context above described, the technical task underlying the presented invention is to propose a container for food that overcomes at least some of the drawbacks of the prior art mentioned above.

In particular, the objective of the present invention is to provide a container for foods capable of preventing contamination of foods during their preparation while allowing them to be perfectly cooked.

The defined technical task and the specified purposes are substantially achieved by a container for food comprising the technical characteristics set out in one or more of the appended claims.

According to the present invention, a container for food is shown.

In particular, the container is configured to ensure optimal preparation (specifically cooking) of food thanks to the exchange of hot air flows with the external environment, while protecting the food from possible contamination by inhibiting the entrance of contaminating elements from the outside.

Structurally, the container comprises a base body, a cover (or lid), and a support.

The base body has a bottom wall and a side wall.

The side wall extends away from the bottom wall and defines with it a chamber inside which it is possible to insert the food to be prepared.

The cover has a central portion and a peripheral portion.

The central portion is configured to define, in a use configuration, an upper wall of the chamber.

The peripheral portion extends away from the central portion.

Advantageously, the cover and specifically the central portion has a greater extension than the respective extension of the bottom wall.

In this way, while in use, the peripheral portion is peripherally external and facing the side wall, so as to provide the base body with protection against the entrance of potentially contaminating elements from the outside.

The support is configured to distance the cover from the base body.

In particular, the support maintains a lower edge of the peripheral portion at most at a same height as an upper edge of the side wall.

This characteristic allows to define between the cover and the base body a passage adapted to allow the free flow of an air flow to and from an external environment with respect to the chamber.

Advantageously, the container described herein guarantees optimal cooking of foods by allowing air to enter and exit the chamber, at the same time protecting them from possible contaminants thanks to the central and peripheral portions of the cover which prevent access to contaminants coming from the outside, in order to ensure food safety.

The dependent claims, incorporated herein for reference, correspond to different embodiments of the invention.

### BRIEF DESCRIPTION OF DRAWINGS

Further characteristics and advantages of the presented invention will become clearer from the indicative, and therefore non-limiting, description of a preferred but not exclusive embodiment of a food container, as illustrated in the accompanying drawings in which:

FIG. 1A shows a first possible embodiment of the container;

FIG. 1B shows a sectional view of FIG. 1A;

FIG. 2A shows a further possible embodiment of the invention;

FIG. 2B shows a sectional view of FIG. 2A;

FIG. 3 shows a detail in view of FIG. 2B;

FIG. 4A shows a particular embodiment of a component of the container;

FIG. 4B shows a sectional view of FIG. 4A;

FIG. 5 shows a further possible embodiment variant for one of the components of the container.

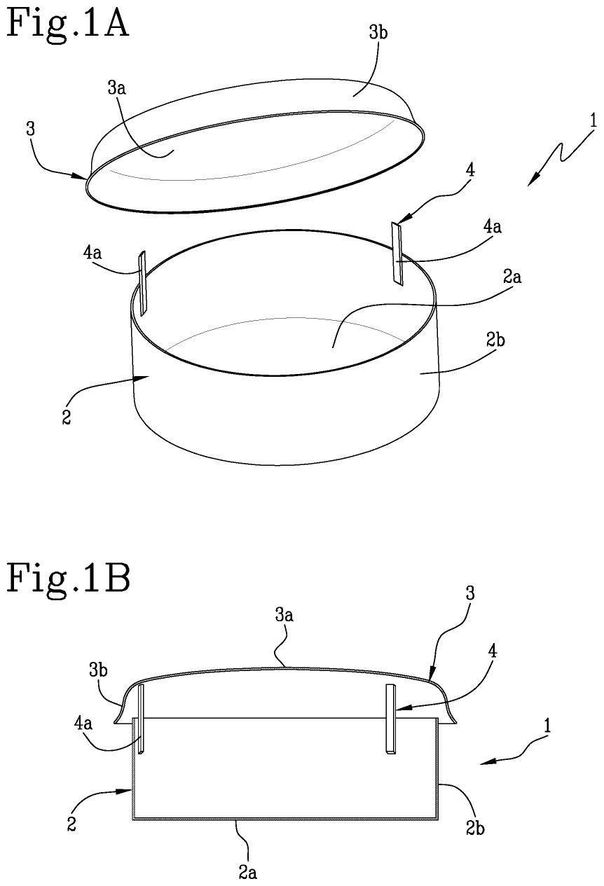

In the attached figures, the numerical reference 1 generically indicates a container for food, to which it will be made reference in the following of the present description simply as container 1.

### DETAILED DESCRIPTION OF THE INVENTION

The container 1, object of the present invention, is specifically configured and designed for the prevention of food contamination, especially during its preparation, while ensuring optimal cooking.

In other words, as will be detailed below, the container 1 has a combination of characteristics such that it is possible to prevent the contact of contaminants with the foods present inside the container while allowing at the same time the free flow of air.

The terms ‘contaminants’ and ‘contaminating agents’ are intended to include any substance that can compromise the food safety of food for a consumer, such as gluten (brought by food particles) for people with coeliac disease or specific allergens for people with allergies to these allergens.

Structurally, the container comprises a base body 2, a cover 3, and a support 4.

The base body 2 has a bottom wall 2a and a side wall 2b which extends away from the bottom wall perpendicularly (or in a substantially perpendicular way) to it, defining a chamber inside which it is possible to insert and contain the food to be prepared.

Therefore, operationally, the walls of the base body 2 define a chamber—identified below in an indicative (i.e., by way of example) and non-limiting way as a cooking chamber—inside which the preparation and/or storage of food is carried out.

In accordance with possible preferential embodiments, the base body is, defines, or comprises a pot, a pan, a baking tray, or in general any kitchen tool/utensil suitable for containing food and preferably inside which it is also possible to cook foods or carrying out one or more phases of their preparation.

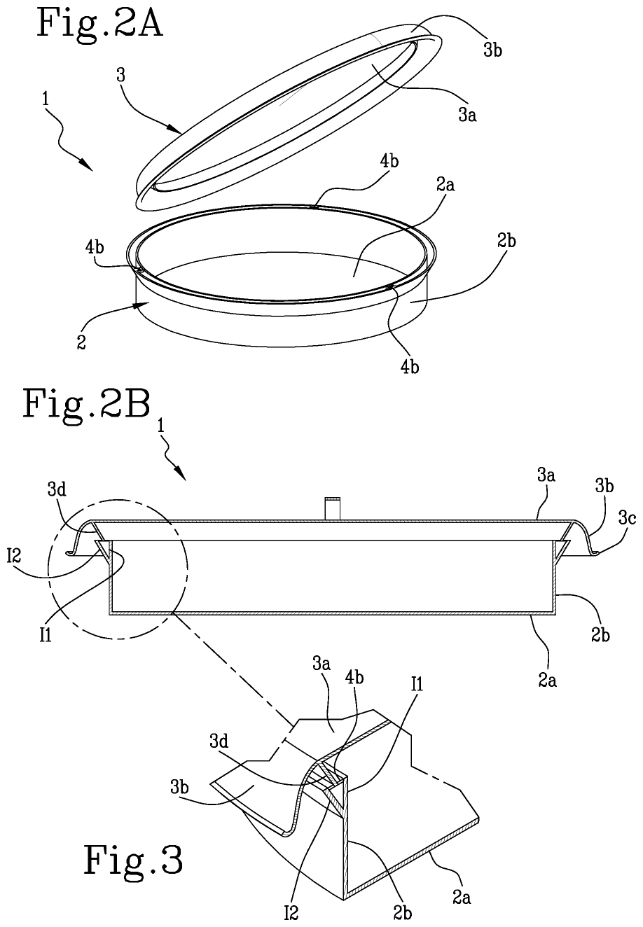

In accordance with an aspect of the present invention, illustrated in FIGS. 2A-2B and in greater detail in FIG. 3, the side wall 2b comprises at its upper edge an inner panel I1 and an outer panel I2.

In greater detail, the inner panel I1 develops as a continuation of the lower portion of the side wall 2b, while the outer panel I2 is inclined by a predefined angle with respect to this lower portion, extending away from it until it arrives preferably at the same height as the inner panel I1.

The specific conformation of the side wall 2b just described allows to define a peripheral channel (or perimeter channel) open above that develops around the upper edge of the base body 2.

As it will become clearer below, the peripheral channel cooperates with the cover 3 in retaining contaminants, hindering their entrance into the cooking chamber.

In particular, the peripheral channel acts as a collection point for the contaminants that fall inside it by gravity and are trapped, thus avoiding the risk of them entering the cooking chamber.

To further optimize this aspect, the peripheral channel can comprise a coating layer made of a material suitable for retaining the contaminants that the user wants to prevent from coming into contact with the food inside the cooking chamber.

For this purpose, the material used to make the coating can be in particular a viscous material and/or a material with adhesive properties or in general any material/substance with characteristics such as to allow the retention of contaminants, in particular powdered contaminants such as flours that may contain gluten.

By way of example, the coating can be made by applying an oily material, for example an edible oil, to the internal edges of the peripheral channel.

While in use, the contaminants that pass in correspondence with the upper edge of the base body 2 (thus risking to enter the cooking chamber) necessarily pass through the peripheral channel and the coating layer assists in their retention further hindering their movement and thus reducing the risk that they can overcome the obstacle that is created in use by the combination cover 3-base body 2.

In this way, it is also avoided that the flow of an air flow along the upper edge of the side wall lifts and moves the contaminants transporting them inside the cooking chamber both during the preparation of the food and when the container 1 is handled/moved.

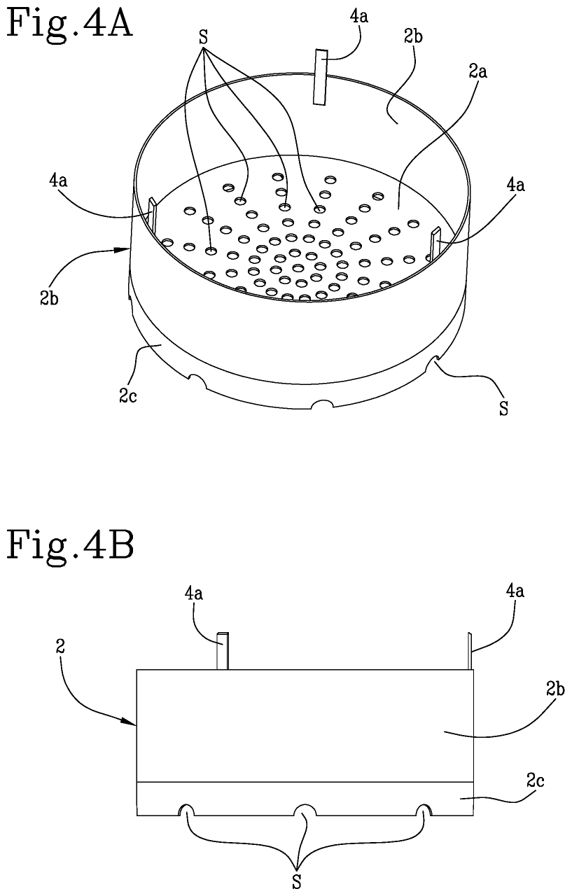

As shown in the attached FIGS. 4A and 4B, the base body 2 can also comprise a further wall that develops below the bottom wall in such a way as to keep it raised and therefore detached from a support plane of the container 1.

In particular, the base body 2 comprises a support wall 2c which extends away from the bottom wall 2a in the opposite direction with respect to the side wall 2b, preferably defining a continuation of the side wall 2b below the bottom wall 2a.

Therefore, the base body 2 is divided into two distinct chambers, i.e., the cooking chamber—delimited by the side wall 2b and the bottom wall 2a—and a lower chamber—delimited by the support wall 2c and the bottom wall 2a.

Advantageously, the support wall 2c can have through seats S which allow the free passage of air to and from the lower chamber, making possible greater convective ventilation of this chamber.

Additionally, or alternatively, also the bottom wall can have respective through seats S useful in particular for the discharge of the humidity that can accumulate in the chamber where the foods to be prepared are positioned, but also to allow the entrance of convective flows inside the cooking chamber.

Overall, by making through seats S both in the support wall 2c and in the bottom wall 2a it is possible to optimize the cooking process further improving the aeration of the food without at the same time compromising the function of protection from contamination given by the joint effect obtained during the use of the base body 2 and the cover 3.

In fact, the air can circulate freely under the cooking chamber, possibly entering it through the through seats S made in correspondence with the bottom wall 2a, while the contaminating agents can in any case be hindered remaining blocked outside the support wall 2c or depositing in the lower chamber where they do not in any case come into contact with the food in the cooking chamber.

Regardless of the specific characteristics and conformations identified above for the base body 2, the cooking chamber has an upper opening that can be closed by means of the cover 3.

In other words, the lid 3 can be coupled as a whole to the base body 2 in such a way as to define an at least partial cover/closure of the cooking chamber.

Specifically, the lid 3 has a substantially planar central portion 3a (preferably plate-like) configured to define in a use configuration an upper wall of the cooking chamber.

Therefore, during food preparation the lid is placed on the base body 2, defining the upper wall of the cooking chamber by means of its central portion 3a.

The cover 3 further has a peripheral portion 3b which develops away from the central portion, effectively forming an edge of this cover 3.

The cover 3, in particular its central portion 3a, has an extension greater than a respective extension of the bottom wall 2a, so that in the configuration of use the peripheral portion 3b is peripherally external and facing the side wall 2a of the base body 2.

In other words, the cover 3 has larger dimensions than those of the base body 2 so that when the two are coupled, the peripheral portion 3b of the lid 3 is arranged around the upper edge of the side wall 2 and is separated and spaced from it.

Operationally, the coupling between the cover 3 and the base body 2 is mediated by the support 4 which is in use interposed between the two.

In particular, the support 4 is configured to distance the lid 3 from the base body 2 by a predefined distance (which is a function of the specific dimensions and the specific structural conformation of the constituent elements of the container 1).

In particular, the distance between the base body 2 and the cover 3 along a vertical direction is defined (or at least partially defined) by the characteristics of the support 4, while the distance along a horizontal direction is defined by the dimensions of the cover 3 with respect to those of the base body 2 (specifically of its bottom wall 2a) and the shape of the peripheral portion 3b of the cover 3.

Operationally, the support 4 is dimensioned in such a way as to maintain a lower edge of the peripheral portion 3b at most at a same height as an upper edge of the side wall 2b, defining between the cover 3 and the base body 2 a passage capable to allow the free passage and flow of an air flow to and from an external environment with respect to the chamber (while at the same time the contaminants are blocked at the top by the lid 3 and laterally by the cooperation between the peripheral portion 3b and the side wall 2b).

In other words, the coupling between the lid 3 and the base body 2 mediated by the support 4 prevents the entrance of contaminants into the chamber from upper and lateral directions, while at the same time defining a passage through which the flow of the air flow is not hindered.

Overall, the base body 2, the lid 3, and the support 4 therefore cooperate to simultaneously obtain the protection of the foods from possible contamination and their optimal cooking.

In fact, the support 4 keeps the base body 2 and the lid 3 distanced in such a way as to define the passage through which the air can freely flow into and from the cooking chamber while maintaining high-quality levels for the food preparation process, while the cover 3 in combination with the base body 2 as they are coupled thanks to the support 4 prevents the entrance of contaminants.

Specifically, it is therefore made impossible for contaminants to enter the cooking chamber when these contaminants come from the top or from the sides of the container 1 being respectively blocked by the central portion 3a or by the peripheral portion 3b of the lid 3, while the convective flows that bring heat are free to move coming into contact with food.

To optimize the blocking function to the passage of contaminants, without however placing obstacles to the free passage of air, the lower edge of the peripheral portion 3b can extend in the configuration of use to a lower level than the upper edge of the side wall 2b, thus going to close even more around it.

In general, the support 4 helps to keep the cover 3 and the base body 2 always separated by a minimum distance of 0.1 cm.

For the purposes of this description, the expression ‘minimum distance’ is therefore intended to identify the minimum cross-sectional dimension of the passage defined between the cover 3 and the base body 2 through which the air flows pass to enter/exit the cooking chamber.

The value indicated above guarantees the correct passage of air flows; in fact, values lower than the limit indicated above can make it impossible for the air to enter the cooking chamber, allowing at the most the escape of air present in the inside it under the push of the progressive accumulation of pressure during food preparation.

Advantageously, the lid 3 can further comprise a collection portion that helps to retain contaminants by preventing their entrance into the cooking chamber.

This characteristic can be seen in particular in the detail of FIG. 3, where it is possible to identify a flap that develops starting from the peripheral portion 3b of the lid 3.

Therefore, the lid 3 can have a collection portion 3c which extends externally to the peripheral portion 3b, away from the latter, in the direction of the plane of the central portion 3a.

This particular conformation is such that the peripheral portion 3b and the collection portion 3c contribute to define a collection channel open above inside which any contaminants fallen on the lid 3 during the use of the container 1 are accumulated.

In this way, even when the cover 3 is lifted, the contaminants remain trapped in the collection channel and cannot flow or slide along the wall of the cover 3 with the consequent risk of accidentally falling back into the cooking chamber.

Therefore, even contaminants that are dispersed in the air at the beginning or during the preparation of the food introduced into the cooking chamber are effectively blocked and at least partly collected and retained in the collection channel as the effect of gravity makes them fall back down.

It is therefore possible to remove them completely during the cleaning of the cover 3 without the risk that its handling causes a new dispersion of contaminating agents.

In order to further hinder the mobility of the contaminating agents with respect to the container, regardless of the presence of the collection channel and of the other structural specificities described above, the external surfaces of the base body 2 and of the cover 3 can be not smooth, or have a surface roughness aimed at preventing any contaminants from sliding on them.

In accordance with a particular aspect of the present invention, the support 4 comprises a plurality of rods 4a available vertically to form spacers to keep the base body 2 and the lid 3 separate.

These spacers can be telescopic or in any case movable vertically so as to modify the distance between the base body 2 and the cover 3.

In particular, the rods 4a can be integral—specifically, coupled or made as a piece—with the base body 2, and preferably positioned at the side wall 2b, or directly coupled to the latter, in such a way as to protrude beyond its upper edge, so that in use the lid 3 is arranged to rest on the rods 4a, keeping its central portion spaced from the base body 2 along a vertical direction for a distance equal to the protruding portion of the rods 4a.

In this context, the peripheral portion 3b of the lid can have an extension equal to that of the protruding portion of the rods 4a so as to keep—in use—its lower edge flush with the upper edge of the side wall 2b, or have a greater extension so as to extend below that upper edge.

In accordance with a possible alternative embodiment, the rods 4a can be integral—specifically, coupled or made in one piece—with the cover 3, preferably in correspondence with a position of its central portion 3a such that in use the rods 4a remain however positioned at least partially inside the base body 2.

In this context, in the configuration of use, the cover 3 is arranged resting on the base body 2 by means of the rods 4a.

In particular, the rods 4a are arranged resting on the bottom wall 2a or the side wall 2b of the base body 2.

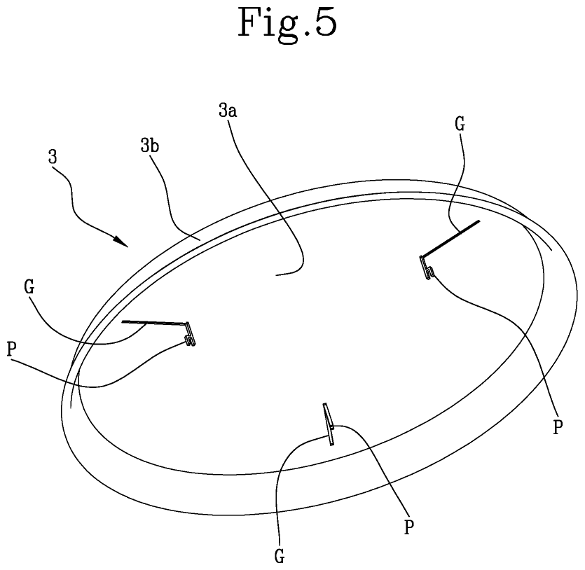

As illustrated in FIG. 5, each rod 4a can comprise an elastically deformable gripper P configured to engage and retain the upper edge of the side wall.

In particular, each rod 4a has a first end coupled and constrained to the cover 3 and a second end, opposite to the first, in correspondence with which the gripper P is.

In other words, thanks to the grippers P it is possible not only to couple but also to constrain the lid to the side wall 2b of the base body 2, engaging its upper edge, further improving the overall stability of the container 1.

Advantageously, each rod 4a can be hinged to the lid 3, in such a way as to be foldable against the central portion 3a when the lid is not in use, thus reducing its overall dimensions.

In particular, each rod 4a can be hinged to the cover 3 at its first end.

FIG. 5 also illustrates some guides G along which the rods 4a are movable in sliding.

In particular, the cover 3 comprises a plurality of radial guides (in the illustrated case, in a number equal to the number of rods 4a) arranged in the central portion 3a.

Each rod 4a is therefore slidingly coupled to the respective guide G at its first end, so as to be movable away from and towards the peripheral portion 3b.

In this way, it is possible to easily adapt the cover 3 to base bodies 2 having different dimensions.

In fact, it is possible to make the rods 4a slide along the respective guides G until they are positioned in correspondence with the side wall 2b of the base body and keep them in position by coupling the grippers P to the upper edge of the side wall 2b.

It follows from the above that the lid 3 in its configuration in which it is directly coupled to the support 4—both made according to one or more of the technical specifications described up to now—can be applied not only to the specific base body 2 presented up to now but also to any base body 2 known and pre-existing.

In particular, the lid 3 and the support 4 can define an independent element that can be implemented to improve any pre-existing container making it capable of being used for optimal preparation of foods, while protecting them from possible contamination.

Therefore, a possible aspect of the present invention also relates to a protection device which comprises a lid 3 having a central portion 3a and a peripheral portion 3b developing away from the central portion 3a and a support 4 coupled, constrained, integral or made in one piece with the cover 3, allowing to distance it from a generic base body defining a cooking chamber, which is preferably made in the form of a base body 2 having one or more of the characteristics presented up to now.

In accordance with a further aspect of the present invention, the support 4 is made by means of carving, preferably periodic carving, made at the upper edge of the side wall 2b and aimed at defining a plurality of elements on which the lid 3 can rest (in particular its central portion 3a) and between which through seats are defined through which the air flow can flow.

By way of example, this carving can be made according to a triangle-shaped profile in which the air flow flows between adjacent triangles or with a sinusoidal profile.

In accordance with a further aspect, the support 4 is defined by means of a pair of shape-coupled elements arranged or made one on the lid 3 and one in correspondence with the upper edge of the base body 2.

In this context, a first element of the support 4 is defined by a plurality of guides made inside the side wall 2b of the base body and preferably having respective ramp conformations.

A second element of the support 4 is shaped and configured to engage said guides and slide along them in such a way as to cause the progressive lifting of the cover 3 by means of a rotation of it with respect to the base body 2.

For example, the second element can comprise a plurality of arms or plates or similar elements which can be associated with respective guides to slide along them causing the lid to gradually lift, thus defining the passage having the characteristics outlined above.

In other words, the support 4 can comprise a guide defined and made inside the side wall (or on its face facing the chamber) and one or more elements that can be coupled and sliding in this guide.

These coupled and sliding elements are coupled, constrained or made in one piece with the cover 3.

According to a possible further embodiment of the container 1, illustrated specifically in FIGS. 2A and 2B, the base body 2 has the peripheral channel and the support 4 is positioned inside it.

In particular, in this context the support 4 comprises a plurality of flanges 4b arranged, preferably equidistant from each other, within the peripheral channel, operationally defining distinct and separate support surfaces for the cover 3.

In this context, the lid 3 has an engagement portion 3d, specifically configured to rest on the flanges 4b, which extends away from the central portion 3a and in a peripherally internal position with respect to the peripheral portion 3b.

In other words, the engagement portion 3d defines a further edge of the lid 3, internal with respect to the peripheral portion 3b, which is arranged in use in an intermediate position of the peripheral channel by engaging the flanges 4b arranged inside it.

Overall, therefore, the cover 3 and the peripheral channel contribute to defining a passage that has a serpentine conformation, which does not hinder the free flow of air flows, but prevents the passage of contaminating agents.

This specific embodiment is particularly suitable for blocking also possible contaminants coming from lower or lower-side angles or positions in addition to the already provided protection from upper and lateral positions.

In fact, the contaminants could be pushed precisely by the convective flows that the user wants to go inside the cooking chamber or, more realistically, pushed by more or less accidental ventilations such as that induced by the use of bellows for wood ovens or that caused by the handling of pizza peels.

In the situation just outlined, any contaminants that should go beyond the peripheral portion 2b coming from below or from lower/lower-side angles or positions would inevitably collide against the engagement portion 3d and therefore fall back into the peripheral channel where they would be retained (especially if the coating layer is also present) without the possibility of accidentally entering the cooking chamber.

Advantageously, the present invention achieves the proposed aims by overcoming the drawbacks complained of in the known art by providing the user with a container for food having a configuration such as to guarantee at the same time optimal preparation and containment of foods without the risk of contaminating them.

I claim:

1-15: (canceled)

16. A container for preparing food comprising:
a base body (2) having a bottom wall (2a) and a side wall (2b) extending away from the bottom wall (2a) so as to define a chamber adapted to receive and contain a food to be prepared;
a cover (3) having a central portion (3a) configured to define in a use configuration an upper wall of said chamber and a peripheral portion (3b) extending away from the central portion (3a), said cover (3) having an extension greater than a respective extension of the bottom wall (2a) so that in the use configuration the peripheral portion (3b) is peripherally external and facing the side wall (2b); and,
a support (4) configured to distance the cover (3) from the base body (2) so as to maintain, when in the use configuration, a lower edge of the peripheral portion (3b) at most at a same height as an upper edge of the side wall (2b) preventing contaminants from entering the chamber from side and upper directions and defining between the cover (3) and the base body (2) a passage adapted to allow the free flow of an air flow to and from an external environment with respect to the chamber.

17. The container of claim 16, wherein the side wall (2b) comprises at the upper edge an inner panel (I1) and an outer panel (I2) cooperating to define a peripheral channel open above.

18. The container of claim 17, wherein the support (4) comprises a plurality of flanges (4b) arranged, preferably equidistant, within said peripheral channel and the cover (3) comprises an engagement portion (3d) extending away from the central portion (3a) and peripherally internal with respect to the peripheral portion (3b), said engagement portion (3d) being configured to be arranged resting on said flanges (4b) when in the use configuration, preventing contaminants from entering the chamber from lower and lower-side directions.

19. The container of claim 18, wherein the base body (2) is a pot or a pan or a tray.

20. The container of claim 18, comprising a support wall (2c) extending away from the bottom wall (2a) in the opposite direction to the side wall (2b), said support wall (2c) being adapted to keep the bottom wall (2a) raised with respect to a support plane of the container.

21. The container of claim 20, wherein the support wall (2c) and/or the bottom wall (2a) have through seats(S) adapted to allow the passage of an air flow.

22. The container of claim 17, wherein the peripheral channel comprises a coating layer adapted to retain contaminants.

23. The container of claim 18, wherein in the use configuration the lower edge of the peripheral portion (3b) extends below the upper edge of the side wall (2b).

24. The container of claim 18, wherein the cover (3) has a collection portion (3c) extending externally to the peripheral portion (3b) so as to define with said peripheral portion (3b) a collection channel open above.

25. The container of claim 18, wherein the support (4) comprises a plurality of rods (4a) integral with the base body (2), in the use configuration said cover (3) being arranged resting on said rods (4a).

26. The container of claim 18, wherein the support (4) comprises a plurality of rods (4a) integral with the cover (3), in the use configuration said rods (4a) being arranged resting on the bottom wall (2a) or the side wall (2b).

27. The container of claim 26, wherein each rod (4a) has a first end coupled to the cover (3) and a second end comprising an elastically deformable gripper (P) configured to engage and retain an upper edge of the side wall (2b).

28. The container of claim 26, wherein each rod (4a) is hinged to the cover (3) at the respective first end.

29. The container of claim 27, wherein each rod (4a) is hinged to the cover (3) at the respective first end.

30. The container of claim 26, wherein the cover (3) comprises a plurality of radial guides (G) arranged in the central portion (3a), each rod (4a) being slidably coupled to a respective guide (G) at the first end so as to be movable away from and towards the peripheral portion (3b).

31. The container of claim 27, wherein the cover (3) comprises a plurality of radial guides (G) arranged in the central portion (3a), each rod (4a) being slidably coupled to a respective guide (G) at the first end so as to be movable away from and towards the peripheral portion (3b).

32. The container of claim 28, wherein the cover (3) comprises a plurality of radial guides (G) arranged in the central portion (3a), each rod (4a) being slidably coupled to a respective guide (G) at the first end so as to be movable away from and towards the peripheral portion (3b).

33. The container of claim 29, wherein the cover (3) comprises a plurality of radial guides (G) arranged in the central portion (3a), each rod (4a) being slidably coupled to a respective guide (G) at the first end so as to be movable away from and towards the peripheral portion (3b).

34. The container of claim 16, wherein:
the base body (2) is a pot or a pan or a tray;
in the use configuration the lower edge of the peripheral portion (3b) extends below the upper edge of the side wall (2b); and, the cover (3) has a collection portion (3c) extending externally to the peripheral portion (3b) so as to define with said peripheral portion (3b) a collection channel open above.

35. The container of claim 17, wherein:
the base body (2) is a pot or a pan or a tray;
in the use configuration the lower edge of the peripheral portion (3b) extends below the
upper edge of the side wall (2b); and, the cover (3) has a collection portion (3c) extending externally to the peripheral portion (3b) so as to define with said peripheral portion (3b) a collection channel open above.
